(19) United States
(12) Patent Application Publication
(10) Pub. No.: US 2010/0045611 A1
(43) Pub. Date: Feb. 25, 2010

(54) TOUCH SCREEN MOBILE DEVICE AS GRAPHICS TABLET INPUT

(75) Inventors: Paul Nelson, Beijing (CN); Sun Shaw, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/196,232

(22) Filed: Aug. 21, 2008

(51) Int. Cl. G06F 3/041; H04W 99/00

(52) U.S. Cl. 345/173; 455/3.06

(57) ABSTRACT

A system and method for using a mobile device having a touch screen as a graphics tablet input device for a user computer is disclosed. A graphics tablet application executing at the mobile device displays a simulated graphics tablet surface and, optionally, programmable or nonprogrammable soft buttons. The graphics tablet application configures the mobile device to be recognized as a graphics tablet input device when connected to the user computer and sends an indication of user input to the user computer. A mobile device support pad stabilizes the mobile device while it is used as a graphics tablet input device. A recess in the support pad having length, width, and depth dimensions that are substantially similar to dimensions of the mobile device restricts movement of the mobile device and places the touch screen of the mobile device in substantially the same plane as a top surface of the support pad.

### BACKGROUND

Graphics tablets, also known as digitizing tablets, graphics pads, and drawing tablets, are a type of input device typically used with desktop computers as an alternative to, or in conjunction with, other input devices, such as a mouse or trackball. Graphics tablets, such as those manufactured by Wacom, typically comprise a flat surface for drawing and a drawing tool, such as a pen, stylus, puck, or mouse device. Graphics tablets may also include a number of programmable or nonprogrammable buttons for performing various tasks or functions, such as copying or pasting data, starting an application, or performing a macro. Graphics tablets are available in a variety of shapes and sizes and can connect to a desktop computer via a number of connection types, such as a serial connection, a USB connection, a Bluetooth connection, etc. Graphics tablets can operate in “absolute” or “relative” modes. In absolute mode, a location on the flat surface of the graphics tablet corresponds to a position on the display of a user computer. In relative mode, the graphics tablet behaves more like a mouse in that the position of a cursor on the display is not associated with any position on the flat surface. Because the flat surface and drawing tool of the graphics tablet are used much like pencil and paper, graphics tablets are often used by artists, such as computer-aided design (“CAD”) users, graphical designers, technical illustrators, etc., to generate digital images. Graphics tablets are also used by artists and non-artists as pointing devices because they are considered by many to be more intuitive and natural to use than a mouse or trackball. Graphics tablets are the preferred input device for many users but, due to their size, can consume a relatively large amount of desktop space and are not considered portable.

Portable mobile devices, such as mobile phones and personal digital assistants (“PDAs”), are used by many and are becoming more and more common throughout the world. Mobile devices, while compact and easy to transport, provide a host of features and services, such as communications, information storage and retrieval, multimedia entertainment, etc. Users may interact with some mobile devices, such as the HTC Touch Diamond, via an integrated touch screen. A user may interact with the touch screen using, for example, a finger or some other pointing device, such as a stylus. Through the touch screen, a user can write, draw, interact with various menus or applications, make telephone calls, compose and send emails, etc. The touch screen provides an intuitive method for interacting with applications and features of the mobile device.

### SUMMARY

A system and method for using a mobile device having a touch screen as a graphics tablet input device for a user computer is disclosed. A graphics tablet application executing at the mobile device may replace a standard display of the mobile device with a simulated surface of a graphics tablet. A user may interact with the graphics tablet application by drawing on the touch screen of the mobile device. As the user draws across the touch screen of the mobile device, the graphics tablet application samples the position of the user input at a predetermined rate and transmits an indication of this position information, such as x, y position information or a recognized symbol, to the user computer where the input can be further processed. Because the mobile device may be connected to a user computer for any number of reasons, such as to copy data to or from the mobile device, charge the mobile device, or upgrade the firmware of the mobile device, a graphics tablet application may also be responsible for configuring the mobile device to be recognized as a graphics tablet input device or some other pointing device when connected to the user computer.

The graphics tablet application may disable or modify various features of the mobile device while the graphics tablet application is active. A user may configure the behavior of each feature of the mobile device while the graphics tablet application is active. When the graphics tablet application is terminated, each feature of the mobile device may return to its normal configuration.

A support pad for the mobile device may also be provided to maintain stability of the mobile device while it is being used as a graphics tablet input device and also to avoid damaging the mobile device. A recess at or near the center of the support pad may be designed such that its length, width, and depth dimensions are substantially similar to the corresponding dimensions of the mobile device so that when the mobile device is placed within the recess of the support pad, its movement is restricted and the surface of the mobile device is substantially coplanar with a surface of the support pad. Each support pad may include at least one passage for cabling from an exterior side wall of the support pad through to a side wall of the recess. Each support pad may comprise a number of layers including a nonskid bottom layer to prevent the support pad from sliding while in use, a resilient body layer composed of, for example, foam rubber or NEOPRENE, and a smooth top layer to provide a comfortable surface for a user to rest and glide his or her hand while using the mobile device as a graphic tablet input device from the support pad.

This Summary is provided to introduce a selection of concepts in a simplified form that are further described in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 is a system diagram showing the environment in which a mobile device may operate as a graphics tablet input device in some embodiments.

FIG. 2 is a block diagram showing components of the mobile device graphics tablet input system in some embodiments.

FIG. 3 is a flow diagram showing the processing of an initialization component of the graphics tablet application in some embodiments.

FIG. 4 is a flow diagram showing the processing of an input processing component of the graphics tablet application in some embodiments.

FIG. 5 is a flow diagram showing the processing of a graphics tablet interface component of a user computer in some embodiments.

FIG. 6A is a representation of a mobile device in some embodiments.

FIG. 6B is a top view of a mobile device support pad in some embodiments.

FIG. 6C is a side view of a mobile device support pad in some embodiments.

### DETAILED DESCRIPTION

A system and method for using a mobile device having a touch screen as a graphics tablet input device for a user computer is disclosed. In some embodiments, a graphics tablet application executing at the mobile device may replace a standard display of the mobile device with a simulated surface of a graphics tablet. For example, the graphics tablet application may display a solid color across the entire surface of the touch screen of the mobile device or a grid pattern that can be matched to a grid pattern on the display of the user computer. The simulated graphics tablet surface may also include a number of programmable or nonprogrammable soft buttons that represent buttons found on graphics tablets. Alternatively, the graphics tablet application may configure hard buttons on the mobile device to perform as graphics tablet input device buttons while the graphics tablet application is executing. A user may interact with the graphics tablet application through these buttons or by drawing on the touch screen of the mobile device using, for example, a finger or a stylus. As the user draws across the touch screen of the mobile device, the graphics tablet application samples the position of the user input at a predetermined rate and transmits an indication of this position information to the user computer. For example, the graphics tablet application may transmit x, y position data to the user computer. As another example, the graphics tablet application may attempt to recognize a symbol (e.g., alphanumeric characters or punctuation) and transmit a Unicode value for the recognized symbol to the user computer. As another example, the graphics tablet application may include an input method component for recognizing characters not found on the input device, such as Microsoft's Input Method Editor (IME). As another example, a user may interact with a standard or modified keyboard layout (QWERTY, Dvorak, etc.) displayed on the touch screen of the mobile device. The graphics tablet application may also recognize other types of user input, such as when a user “taps” on the mobile device's touch screen or lifts their finger or stylus from the touch screen.

A connection between the mobile device and the user computer may be established in any number of ways, such as a standard serial connection, a USB connection, an IEEE 1394 connection, a network connection, etc. In some cases, the mobile device may be connected to the user computer via a wireless connection (e.g., Bluetooth, Infrared, or Ultra-wideband (UWB)). Because the mobile device may be connected to a user computer for any number of reasons, such as to copy data to or from the mobile device, charge the mobile device, or upgrade the firmware of the mobile device, a graphics tablet application may also be responsible for configuring the mobile device to be recognized as a graphics tablet input device or some other pointing device when connected to the user computer. As an example, a graphics tablet application executing at the mobile device may temporarily alter a plug-and-play identifier of the mobile device. As another example, the graphics tablet application may intercept communications between the mobile device and the user computer during an identification phase of a human interface device (HID) protocol and transmit data. When the user computer receives the indication of the user input, the user computer may process the indication by, for example, moving a cursor across an associated display device, drawing a curve representative of the user input, displaying the recognized symbol, or sending the data to an application for further processing.

In some embodiments, the graphics tablet application may disable or modify various features of the mobile device while the graphics tablet application is active. For example, to prevent interruptions in the use of a mobile telephone device as a graphics tablet input device for a user computer, the graphics tablet application may prevent the mobile telephone device from receiving telephone calls while the graphics tablet application is active. As another example, the graphics tablet application may display an indication of a received call or message on the touch screen of the mobile telephone device, the display of the user computer, or both. By clicking or selecting the call indicator, the user can answer the call or read the received message. In some cases, the graphics tablet application may redirect a telephone call through the user computer so that the user can communicate via a microphone and speaker of the user computer. In some embodiments, a user can configure the behavior of each feature of the mobile device while the graphics tablet application is active. For example, a user may configure a mobile telephone device to send all incoming calls to voicemail or answer all incoming calls in speakerphone mode. When the graphics tablet application is terminated, each feature of the mobile device may return to its normal configuration.

A support pad for the mobile device may also be provided to maintain stability of the mobile device while it is being used as a graphics tablet input device and also to avoid damaging the mobile device. A support pad may be specially designed for each mobile device to provide a custom fit so that the mobile device does not wobble or slide during use. A recess at or near the center of the support pad may be designed such that its length, width, and depth dimensions are substantially similar to the corresponding dimensions of the mobile device so that when the mobile device is placed within the recess of the support pad, its movement is restricted and the surface of the mobile device is substantially coplanar with a surface of the support pad. Each support pad may include at least one passage from an exterior side wall of the support pad through to a side wall of the recess. These passages allow for cabling, such as communications or power cabling, to reach the mobile device while reducing interference with the top and bottom surfaces of the support pad. The support pad may also include a hole or cutout portion passing from the bottom of the support pad to the bottom of the recess. This cutout portion allows a user to easily remove the mobile device from the support pad. Each support pad may comprise a number of layers including a nonskid bottom layer to prevent the support pad from sliding while in use, a resilient body layer composed of, for example, foam rubber or NEOPRENE, and a smooth top layer to provide a comfortable surface for a user to rest and glide his or her hand while using the mobile device as a graphic tablet input device from the support pad. In some embodiments, a support pad may be molded, although one skilled in the art will recognize that support pads may be manufactured in any fashion, such as by machining or stamping.

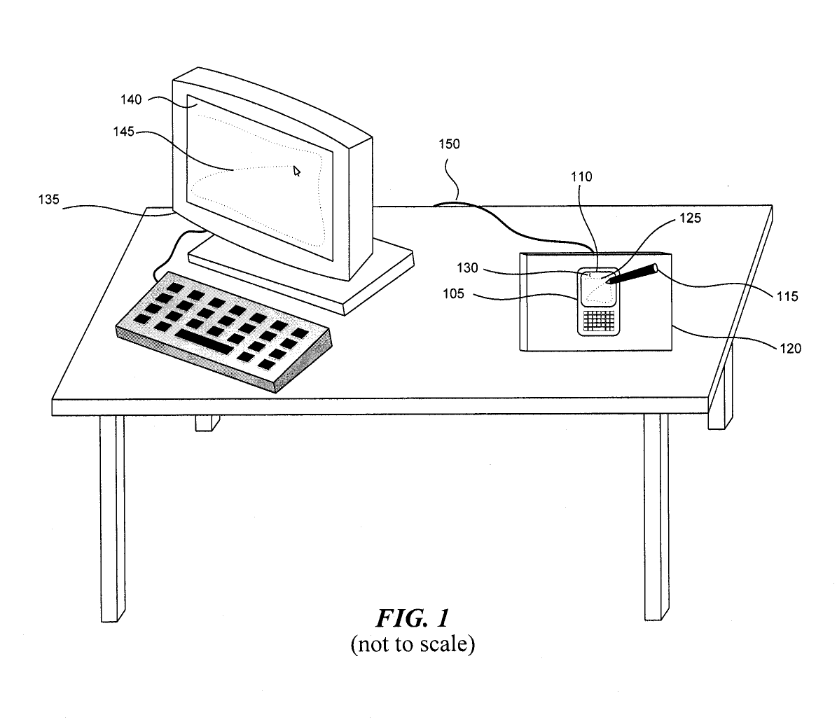

FIG. 1 is a system diagram showing the environment in which a mobile device may operate as a graphics tablet input device in some embodiments. In this embodiment, mobile device 105 having touch screen 110 is positioned within support pad 120 and connected via connection 150 to user computer 135 having display 140. Although in this example connection 150 is a wired connection, one skilled in the art will recognize that connection 150 may be wireless. Users may interact with touch screen 110 using a pointing device, such as stylus 115. In this example, a user has moved the stylus along a path on touch screen 110 reflected by dotted line 125. As the path is recorded at mobile device 105, an indication of the path may be transmitted to user computer 135 via connection 150 to, for example, control a cursor on display 140 reflected by dotted line 145. In some embodiments, mobile device 105 may be used to recognize user input as symbols and transmit the recognized symbols to the user computer. In some embodiments, active features or services of mobile device 105 may be reflected on touch screen 110. For example, icon 130 may be displayed on mobile device 105 to indicate that the user is receiving a telephone call while the device is being used as a graphics tablet input device. The indicator may be animated or flashing to help draw the user's attention to the notification. A similar icon or notification may be reflected on display 140 to notify the user of the telephone call.

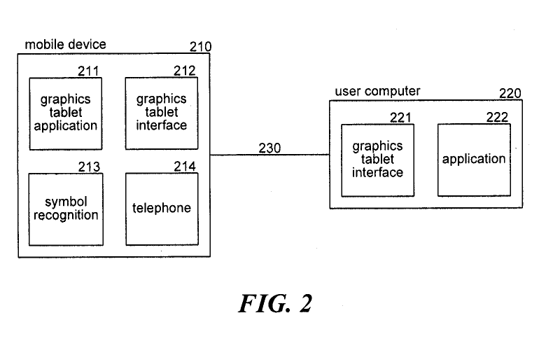

FIG. 2 is a block diagram showing components of the mobile device graphics tablet input system in some embodiments. In this example, mobile device 210 is a mobile telephone device. Mobile device 210 includes a graphics tablet application component 211, a graphics tablet interface component 212, a symbol recognition component 213, and a telephone component 214. Graphics tablet application component 211 is used to configure mobile device 210 for use as a graphics tablet input device and process user input. Graphics tablet application component 211 may, for example, display a user input screen on the touch screen of mobile device 210 and configure mobile device 210 to be recognized as a graphics tablet input device. Graphics tablet interface component 212 converts the processed user input into a graphics tablet data format and transmits the data to user computer 220 using a graphics tablet input device protocol. Symbol recognition component 213, when enabled, is used to recognize user input. Telephone component 214 provides standard services of a mobile telephone device, such as making and receiving voice telephone calls. Some embodiments of mobile device 210 may include additional components, such as a data component for sending and receiving data, a messaging component for sending and receiving messages (e.g., a short message service component, a multimedia message service component, or an electronic mail message component), a multimedia component for recording and playing multimedia files, and so on. In some cases, graphics tablet application component 211 may automatically disable or modify some or all of these components to avoid interrupting the user's experience with the graphics tablet application. For example, graphics tablet application component 211 may disable telephone component 214 to prevent the user from receiving telephone calls while the graphics tablet application is executing. Alternatively, graphics tablet application component 211 may configure telephone component 214 to prevent mobile device 210 from ringing when a call is received and instead display an indication of the call on the mobile device, a display of user computer 220, or both.

User computer 220 includes graphics tablet interface component 221 and application component 222. Graphics tablet interface component 221 receives and processes graphics tablet data from mobile device 210 in accordance with a graphics tablet input device protocol and/or a graphics tablet input device driver installed at the user computer. Graphics tablet interface component 221 may also interact with application component 222 by providing the received user input to the application. For example, a standard word processing application may receive text input from graphics tablet interface component 221 received from mobile device 210. As another example, a graphics editing program may receive drawing input from graphics tablet interface component 221. Data is exchanged or communicated between mobile device 210 and user computer 220 via connection 230. Connection 230 may provide a direct connection between mobile device 210 and user computer 220 via a cable or wireless communications link or may connect the mobile device and user computer over a communications network.

The computing devices on which the mobile device graphics tablet input system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the mobile device graphics tablet input system, which means a computer-readable medium that contains the instructions. In addition, the instructions, data structures, and message structures may be stored or transmitted via a data transmission medium, such as a signal on a communications link, and may be encrypted. Various communications links may be used, such as the Internet, a personal area network, a local area network, a wide area network, a point-to-point dial-up connection, a cell phone network, and so on.

Embodiments of the mobile device graphics tablet input system may be implemented in and used with various operating environments that include personal computers, server computers, handheld or laptop devices, multiprocessor systems, microprocessor-based systems, programmable consumer electronics, digital cameras, network PCs, minicomputers, mainframe computers, computing environments that include any of the above systems or devices, and so on.

The mobile device graphics tablet input system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

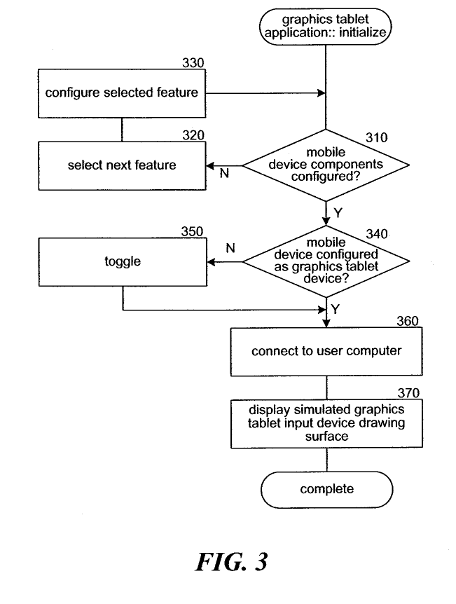

FIG. 3 is a flow diagram showing the processing of an initialization component of the graphics tablet application in some embodiments. The component may be invoked, for example, each time the graphics tablet application is executed. In decision block 310, if all components of the mobile device have been configured for the mobile device to be used as a graphics tablet input device, then the component continues at decision block 340, else the component continues at block 320. In block 320, the component selects the next feature. In block 330, the component configures the selected feature. For example, a telephone or messaging feature of the mobile device may be configured to prevent or limit interruption of the graphics tablet application component. As another example, the graphics tablet application may configure an input orientation of the mobile device for use as a graphics tablet input device. Because some mobile devices may have screens that are taller than they are wide, a user may wish to rotate the mobile device while it is used as a graphics tablet input device for a user computer having a display that is greater in width than height. Furthermore, a left-handed user may wish to rotate the mobile device counterclockwise to reduce interference with keys or the shape of the mobile device, while a right-handed user may wish to rotate the mobile device clockwise. By configuring the input orientation of the mobile device to match the user's preferences, the graphics tablet application can properly translate, rotate, and scale the received input prior to sending it to the user computer. Alternatively, the graphics tablet application may send an indication of the input orientation to the user computer for processing. The component then loops back to block 310. In decision block 340, if the mobile device is configured to be recognized as a graphics tablet input device, then the component continues at block 360, else the component continues at block 350 where the mobile device is toggled to be recognized as a graphics tablet input device. In some embodiments, a plug-and-play or HID identifier of the mobile device is modified to correspond to a graphics tablet input device. In other embodiments, the component configures the graphics tablet application to intercept identification communication messages between a mobile device and a user computer and insert graphics tablet input device identification information into the intercepted messages. In block 360, the component establishes a connection with a user computer. In block 370, the component displays a simulated graphics tablet input device drawing surface on the touch screen of the mobile device and completes.

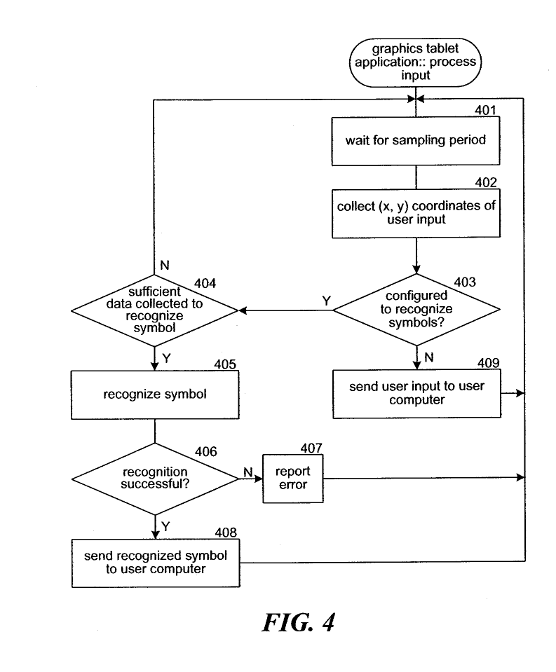

FIG. 4 is a flow diagram showing the processing of an input processing component of the graphics tablet application in some embodiments. This component may be invoked each time a user provides user input via the touch screen of the mobile device. In block 401, the component waits for a predetermined sampling period. In block 402, the component collects the current x, y coordinates of the user input. In decision block 403, if the graphics tablet application is configured to recognize symbols, then the component continues at block 404, else the component continues at block 409 where the component sends the received user input to a user computer and loops back to block 401 to process additional user input. In decision block 404, if sufficient data has been collected to recognize a symbol, then the component continues at block 405, else the component loops back to block 401 to collect additional user input. In block 405, symbol recognition is performed by, for example, sending the received data to a symbol recognition component. In decision block 406, if the symbol recognition was successful, then the component continues at block 408 and sends an indication of the recognized symbol to the user computer, else the component continues at block 407 and reports an error message. The component then loops back to block 401 to collect additional user input.

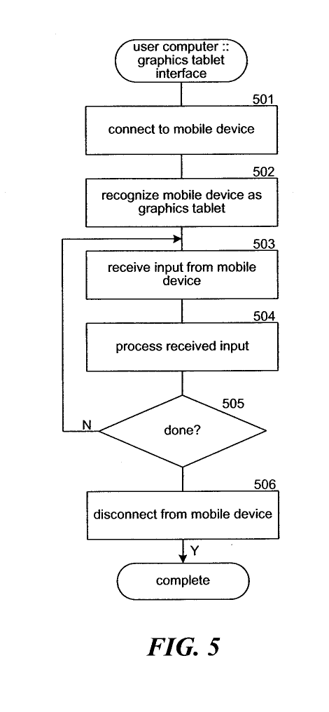

FIG. 5 is a flow diagram showing the processing of a graphics tablet interface component of a user computer in some embodiments. In block 501, the component establishes a connection to the mobile device. In block 502, the component recognizes the mobile device as a graphics tablet. In block 503 the component receives input from the mobile device. The component may receive, for example, position information indicative of a stroke performed by a user across a touch screen of the mobile device. In some embodiments, the component may receive recognized symbols from the mobile device. In block 504 the component processes the received input. For example, the component may update the position of a cursor on the display of the user computer or provide a recognized symbol to an executing application. In decision block 505, if the component is done receiving input from the mobile device, then the component continues at block 506, else the component loops back to block 503 to collect additional input. In block 506, the component terminates the connection with the mobile device and completes.

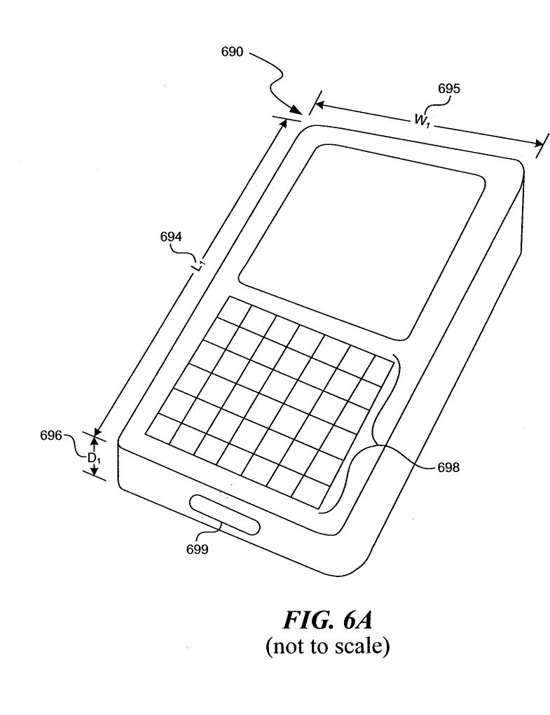

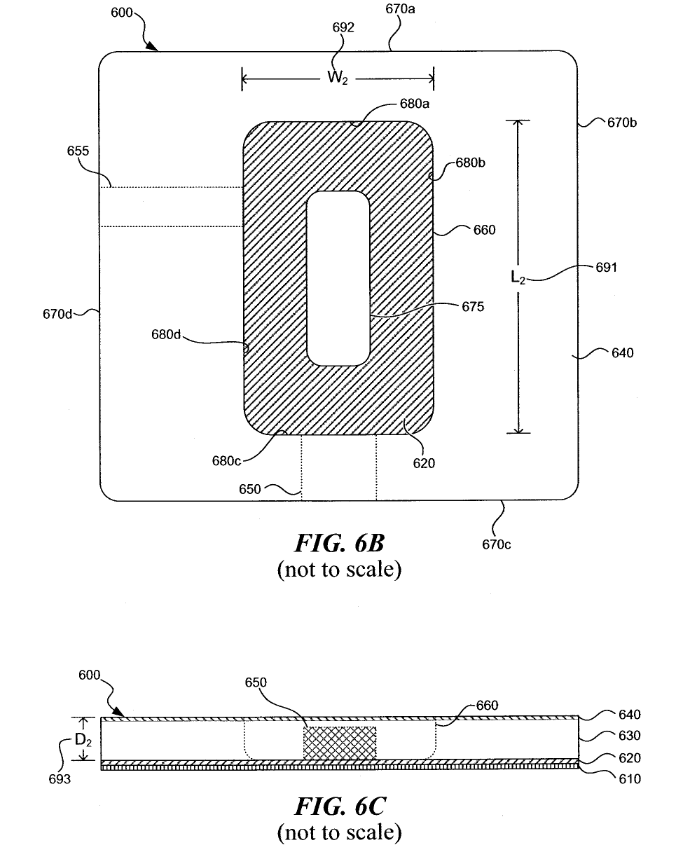

FIG. 6A is a representation of a mobile device in some embodiments. Mobile device 690 includes touch screen 697, keyboard 698, and data communications port 699. A user may interact with the mobile device by, for example, drawing or writing on touch screen 697 with a finger or stylus (not shown) or pressing keys associated with keyboard 698. Mobile device 690 has length 694, width 695, and depth 696 dimensions. Data communications port 699 can be used to connect a cable for exchanging data with another computing device, charging the mobile device, etc.

FIG. 6B is a top view of a mobile device support pad in some embodiments. External vertical surfaces or walls 670a-d form the perimeter of mobile device support pad 600. Mobile device support pad 600 includes a recess 660 having length 691, width 692, and depth 693 (FIG. 6C) dimensions that are equal to, or at least approximately equal to, the length 694, width 695, and depth 696 dimensions of the mobile device to be placed in mobile device support pad 600. For example, if the mobile device has a width dimension of 2.0 inches, the width of a corresponding recess may range from 1.5 to 2.5 inches. Internal vertical surfaces or walls 680a-d form the perimeter of recess 660. When the mobile device is placed within recess 660, lateral movement of the mobile device is limited and the touch screen of the mobile device is substantially coplanar with top layer 640 of mobile device support pad 600 to allow a user to comfortably rest his or her hand while using the mobile device as an input device for a user computer. Because mobile devices are available in various shapes and sizes, a support pad may be manufactured for each mobile device having a touch screen in order to support the varying dimensions of available mobile devices. For example, a mobile device support pad may be manufactured to support a mobile telephone device with a protrusion on one side, such as an antenna. Support layer 620 is constructed of a rigid or semirigid material to reduce or limit the downward movement of the mobile device as a user interacts with the touch screen of the mobile device and may be covered with the same material that forms top layer 640 to protect the mobile device and support layer 620. Cutout portion 675 passes from a bottom layer of mobile device support pad 600 to the bottom of recess 660. Cutout portion 675 allows a user to easily remove a mobile device from mobile device support pad 600 by pushing the mobile device out from its position in recess 660. Passages 650 and 655 allow cabling to pass from an exterior wall 670 of mobile device support pad 600 to an interior wall 680 of mobile device support pad 600 that forms a wall of recess 660. The passages may be positioned to facilitate access to various ports or jacks on the mobile device, such as charging ports, data communications ports, microphone jacks, and so on. In this example, passage 650, as indicated by dotted lines, lies below top layer 640 and creates a tunnel between exterior wall 670c and interior wall 680c. Similarly, passage 655 creates a tunnel between exterior wall 670d and interior wall 680d. In some embodiments, passages 650 and 655 may provide an uncovered channel through mobile device support pad 600 passing through multiple layers of mobile device support pad 600, including top layer 640.

FIG. 6C is a side view of a mobile device support pad in some embodiments. Mobile device support pad 600 comprises four layers: bottom layer 610, support layer 620, body layer 630, and top layer 640. Bottom layer 610 may be made of a gripping or nonskid material, such as rubber, latex, neoprene, textured surfaces, etc., to prevent mobile device support pad 600 from sliding or slipping as a user interacts with a mobile device placed within mobile device support pad 600. Bottom layer 610 also includes a cutout portion (not shown in FIG. 6C) to facilitate removal of a mobile device from mobile device support pad 600. Support layer 620, as discussed above, is composed of a rigid or semirigid layer to prevent or limit movement of a mobile device while placed in mobile device support pad 600. Body layer 630 is composed of a flexible and resilient material, such as a lower density rubber composite, foam rubber, neoprene, encased silicone gel, and so on. Body layer 630 provides cushioning support for a user's hand while interacting with a mobile device placed within recess 660. Top layer 640 covers body layer 630 and is composed of a smooth fabric or other material to allow a user's hand to easily glide across the top surface while providing touch screen input to the mobile device placed within mobile device support pad 600. In some embodiments, top layer 640 may also cover an interior wall of mobile device support pad 600 and/or exposed portions of support layer 620. Passage 650, as discussed above, provides cable access between a mobile device placed within a recess of mobile device support pad 600 and an external wall of mobile device support pad 600. In this example, passage 650 is located below top layer 640, creating a tunnel. The crosshatched pattern represents an interior wall of the mobile device support pad visible through passage 650. In some embodiments, a passage may pass through multiple layers, including top layer 640.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method for using a mobile telephone device having a touch screen as a graphics tablet input device for a user computer, the method comprising:
under control of the mobile telephone device,
executing a graphics tablet application,
under control of the graphics tablet application,
configuring the mobile telephone device to be recognized as a graphics tablet,
displaying a user input window on the touch screen of the mobile telephone device,
receiving handwritten data from the user via the touch screen of the mobile telephone device, and
sending an indication of the received input to the user computer; and
under control of the user computer,
recognizing the mobile telephone device as a graphics tablet,
receiving input from the mobile telephone device, the input indicative of handwritten data received from the user, and
displaying an indication of the received input.

2. The method of claim 1, further comprising:
under control of the graphics tablet application,
in response to receiving an indication of a received telephone call,
displaying an indication of the received telephone call on the touch screen of the mobile telephone device, and
sending an indication of the received telephone call to the user computer.

3. The method of claim 2, further comprising:
under control of the user computer,
receiving an indication of a telephone call from the mobile telephone device, and
displaying an indication of the telephone call.

4. The method of claim 1, further comprising:
under control of the graphics tablet application,
displaying a button on the touch screen of the mobile telephone device, the button corresponding to a function of the graphics tablet application, wherein when the button is selected, the corresponding function is invoked.

5. The method of claim 1, further comprising:
under control of the graphics tablet application,
displaying a keyboard on the touch screen of the mobile telephone device,
receiving a selection of at least one of the keys of the displayed keyboard, and
sending an indication of the at least one of the selected keys to the user computer.

6. The method of claim 1, further comprising:
under control of the graphics tablet application,
configuring a first feature of the mobile telephone device.

7. The method of claim 6 wherein the first feature is a telephone feature of the mobile telephone device and configuring the first feature includes disabling the telephone feature.

8. The method of claim 6 wherein the first feature is a messaging feature of the mobile telephone device.

9. The method of claim 6 wherein when the graphics tablet application is terminated, the first feature is returned to a previous configuration.

10. A computer-readable storage medium containing instructions for enabling a mobile device having a touch screen to be used as a pointing device for a user computer by a method comprising:
displaying an input window on the touch screen of the mobile device;
configuring the mobile device to be recognized as a pointing device;
receiving handwritten data into the input window via the touch screen of the mobile device; and
sending an indication of the received handwritten data to the user computer.

11. The computer-readable storage medium of claim 10, further comprising:
receiving an indication of an input orientation of the mobile device; and
storing the indication of the input orientation of the mobile device.

12. The computer-readable storage medium of claim 11, further comprising:
transforming the received handwritten data based on the stored indication of the input orientation of the mobile device.

13. The computer-readable storage medium of claim 10 wherein the indication of the received handwritten data includes position information.

14. The computer-readable storage medium of claim 10 wherein the indication of the received handwritten data includes a recognized symbol.

15. A support configured to receive a mobile communications device having a touch screen, the mobile communications device having a first length dimension, a first width dimension, and a first depth dimension, the support comprising:
a recess having a second length dimension, a second width dimension, and a second depth dimension, wherein the second length dimension is at least approximately equal to the first length dimension, the second width dimension is at least approximately equal to the first width dimension, and the second depth dimension is at least approximately equal to the first depth dimension; and
a first passage extending from a first exterior surface of the support to the recess, the first passage for guiding cabling from an exterior surface of the support to the mobile communications device.

16. The support of claim 15, further comprising a second passage extending from second exterior surface of the support to the recess, the second passage for guiding cabling from an exterior surface of the support to the mobile communications device.

17. The support of claim 15 wherein when the mobile communications device is placed in the support, lateral movement of the mobile communications device is restricted and the touch screen of the mobile communications device is at least substantially coplanar with a first surface of the support.

18. The support of claim 17, further comprising a second surface opposite the first surface, the second surface being composed of a nonskid material.

19. The support of claim 18, further comprising a cutout portion extending from the second surface to the recess.

20. The support of claim 19 wherein the cutout portion has a third length dimension, a third width dimension, and a third depth dimension, wherein the third length dimension is smaller than the first length dimension, the third width dimension is smaller than the first length dimension, and the third depth dimension is smaller than the first depth dimension.
